(19) United States
(12) Patent Application Publication
(10) Pub. No.: US 2021/0276710 A1
(43) Pub. Date: Sep. 9, 2021

(54) AIRCRAFT AND METHOD FOR OPERATING AN AIRCRAFT

(71) Applicant: SilentWings GmbH, München (DE)

(72) Inventor: Stefan Mändl, Munich (DE)

(21) Appl. No.: 17/262,162

(22) PCT Filed: Jul. 24, 2019
(86) PCT No.: PCT/EP2019/069884

§ 371 Date: Jan. 21, 2021

(30) Foreign Application Priority Data
Jul. 27, 2018 (DE) 10 2018 212 611.9

(51) Int. Cl. B64C 29/02; B64C 1/06; B64C 5/02; B64C 13/50; B64D 31/00

(52) U.S. Cl. CPC B64C 29/02; B64C 1/068; F16H 19/08; B64C 13/50; B64D 31/00; B64C 5/02

(57) ABSTRACT

The invention relates to an aircraft and a method for operating an aircraft comprising at least one fuselage (7), which has a front fuselage section (7a) and a rear fuselage section (7b), at least one wing (1) provided in the region of the front fuselage section (7a), at least one first drive device (2) provided in the region of the front fuselage section (7a) and/or on the wing (1), which is configured to generate propulsion and/or lift, and at least one tailplane (3), which is configured to rotate and/or stabilize the aircraft during flight about a transverse axis of the aircraft, wherein the tailplane (3) is attached to the fuselage (7) and the rear fuselage section (7b) is pivotable relative to the front fuselage section (7a) about a pivot axis (S2) substantially parallel to the transverse axis of the aircraft and/or the tailplane (3) is attached to at least one support element (6) mounted on the fuselage (7) and/or on the wing (1), which support element (6) is pivotable relative to the fuselage (7) or to the wing (1) about a pivot axis (S1) substantially parallel to the transverse axis of the aircraft.

The invention relates to an aircraft and a method for operating an aircraft.

Unmanned aircraft vehicles, also known as Unmanned Aerial Vehicles (UAV), Unmanned Aircraft (UA), Unmanned Aircraft Systems (UAS) or colloquially as drones, are used for different purposes depending on their performance and equipment, for example to transport cargo or for control and monitoring purposes using integrated cameras and/or sensors. Depending on the area of application, different requirements are placed on the climb or take-off, the descent or landing and/or the forward flight or the transition between these types of flight.

It is an object of the invention to disclose an aircraft and a method for operating an aircraft in which different types of flight and/or a transition between different types of flight are or is enabled in a simple and reliable manner.

This object is solved by the aircraft and the method according to the independent claims.

An aircraft according to one aspect of the invention comprises: at least one fuselage comprising a front fuselage section and a rear fuselage section, at least one wing provided in the region of the front fuselage section, at least one first drive device provided in the region of the front fuselage section and/or on the wing and configured to generate propulsion and/or lift, and at least one tailplane configured to rotate and/or stabilize the aircraft during flight about a transverse axis of the aircraft. Preferably, the tailplane is attached to the fuselage, in particular to the rear or front fuselage section, and the rear fuselage section is pivotable relative to the front fuselage section about a pivot axis substantially parallel to the transverse axis of the aircraft. Alternatively or additionally, the tailplane is attached to at least one support element, which is mounted on the fuselage and/or wing and which is pivotable relative to the fuselage or wing about a pivot axis substantially parallel to the transverse axis of the aircraft.

According to a second aspect of the invention, in a method for operating an aircraft, in which the tailplane is attached to the fuselage, the rear fuselage section is pivoted relative to the front fuselage section about a pivot axis substantially parallel to the transverse axis of the aircraft. Alternatively or additionally, in an aircraft, in which the tailplane is attached to at least one support element mounted to the fuselage and/or wing, the support element is pivoted relative to the fuselage or wing about a pivot axis substantially parallel to the transverse axis of the aircraft.

Preferred aspects of the invention are based on the approach of providing the aircraft with a pivotable tail. Preferably, the tailplane, which in particular comprises a horizontal stabilizer and/or an elevator, is attached to the pivotable tail. Alternatively, however, the tailplane can also be attached in the area of the front fuselage section, possibly even in front of the wings. The pivotable tail can be formed, for example, by a rear fuselage section of the fuselage of the aircraft which can be pivoted relative to a front fuselage section, so that the fuselage of the aircraft in this case can also be referred to as a tilt fuselage. Alternatively or additionally, however, the pivotable tail can also be formed by one or more, preferably elongated, support elements, such as profile bars or tubes, which do not necessarily themselves have to be part of the fuselage in the narrower sense, but rather are pivotably mounted on the fuselage and/or on the wing or wings. In both variants, the tailplane, which is preferably located at the distal end of the rear fuselage section or the support elements, can be pivoted together with the rear fuselage section or the support elements relative to the front fuselage section, the fuselage or the wing, respectively, and thereby brought into different pivoted positions or spatial orientations. For example, the tail can be brought into an orientation which is substantially parallel or perpendicular to the fuselage or longitudinal axis of the aircraft.

This allows for different configurations with which the take-off or climb and/or landing or descent and/or forward flight as well as the transition between these types of flight can be realized in a simple and reliable manner.

Preferably, at least one pivoting device or pivoting mechanism is provided, which is configured to pivot the rear fuselage section relative to the front fuselage section and/or the at least one support element relative to the fuselage or the wing about the pivot axis. Preferably, the pivoting device is configured to pivot the rear fuselage section and/or the at least one support element from a first orientation to a second orientation, which is substantially perpendicular to the first orientation. Preferably, the rear fuselage section or the at least one support element extends substantially parallel to the longitudinal axis of the aircraft in the first orientation and substantially perpendicular to the longitudinal axis of the aircraft in the second orientation.

In this way, the pivoting tail can be brought into different positions or orientations that are advantageous, especially during takeoff, forward flight and/or landing.

For example, this allows the aircraft before takeoff and/or after landing to stand on the floor on its angled—i.e., running in the second orientation or perpendicular to the longitudinal axis—tail. In this case, the longitudinal axis of the aircraft is substantially vertical, so that the first drive device, which in conventional aircraft usually generates propulsion for forward flight only, can also serve to generate lift for take-off and/or for a controlled landing of the aircraft.

Preferably, the pivoting device comprises a pivot drive unit, in particular a motor, and a pivot gear, which is mechanically coupled and/or couplable to the pivot drive unit and by which the rear fuselage section is mounted so as to pivot about the pivot axis relative to the front fuselage section and/or the at least one support element is mounted so as to pivot about the pivot axis relative to the fuselage or the wing.

Preferably, the pivot gear is designed as a self-locking gear. Preferably, this can be any type of gear in which friction between adjacent and/or intermeshing gear parts causes resistance to slippage or rotation of the adjacent or intermeshing gear parts. A gear is preferably self-locking if it can be driven via the input shaft but not via the output shaft.

In principle, gears are suitable for this purpose in which a driving gear element, such as a drive shaft in the form of a threaded rod driven by a motor, is coupled via a screw connection to a driven gear element in the form of a nut screwed on the threaded rod. However, a self-locking effect can also be achieved in gear units by means of high gear ratios and/or moments of inertia and/or low efficiencies.

Preferably, the pivot gear comprises a worm gear or the pivot gear is designed as a worm gear. The pivot gear preferably comprises: a helical gear element, in particular a worm, which can be set in rotary motion about a first axis of rotation by the pivot drive unit, and a gearwheel, in particular a worm wheel, which engages in the helical gear element and can be rotated, by a rotary motion of the gear element about the first axis of rotation, about a second axis of rotation which is substantially perpendicular to the first axis of rotation and runs in particular along the pivot axis.

By using at least one such pivot gear, which is designed in particular as a self-locking gear, the rear fuselage section can be pivoted about the pivot axis relative to the front fuselage section or the at least one support element can be pivoted relative to the fuselage or the wing, on the one hand, precisely and, on the other hand, can be reliably held in the pivot position assumed in each case without additional securing elements being mandatory for this purpose.

Preferably, the aircraft comprises at least one second drive device provided on the tailplane and/or on the rear fuselage section and/or on the at least one support element and configured to generate lift.

For example, the second drive device can be designed as a propeller or impeller. An impeller is preferably a propeller enclosed by an annular or tubular housing.

Preferably, the second drive device is designed as an impeller which is integrated into the tailplane attached to the rear fuselage section or to the at least one support element. By integrating an impeller into the tailplane, the aerodynamic properties of the tailplane are improved compared to, for example, a propeller attached to the tailplane. This is particularly true in configurations or modes of operation of the aircraft in which the rear fuselage section or the at least one support element in a first orientation runs or is oriented substantially parallel to the longitudinal axis of the aircraft, which is in particular oriented horizontally, as is the case, for example, in the second hover mode described in more detail below and/or in particular in the forward flight mode. Thus, the second drive device is generally not required to generate a lift, particularly during forward flight, and can be deactivated accordingly. A deactivated impeller integrated into the tailplane then has aerodynamically much more favorable properties than a deactivated propeller mounted on the tailplane.

In principle, however, as an alternative or in addition to an impeller, any other device suitable for generating lift or additional lift can be used, for example a jet engine, turbine jet engine, ramjet engine or rocket engine.

Preferably, the second drive device is arranged and/or configured to generate lift when the tail is in the angled position, i.e., when the rear fuselage section or the at least one support element is oriented substantially perpendicular to the longitudinal axis of the aircraft. In particular, the second drive device generates lift in addition to lift generated, preferably during takeoff and/or landing, by the first drive device when the longitudinal axis is oriented substantially vertically. The lift required for takeoff and/or controlled landing can thus be provided in a particularly reliable and controllable manner.

It is further preferred that the second drive device is arranged and/or configured to generate lift when the rear fuselage section or the at least one support element in the second orientation is substantially perpendicular to the longitudinal axis of the aircraft, which is in particular oriented vertically.

Preferably, the second drive device provided on the tailplane is configured to generate a drive force (A) in at least one direction, wherein, by pivoting, in particular only by pivoting, the rear fuselage section together with the tailplane attached thereto about the pivot axis or the at least one carrier element together with the tailplane attached thereto about the pivot axis, respectively, the second drive device is or can be brought into a position and/or orientation in which the direction of the drive force (A) which can be generated and/or is generated by the second drive device substantially corresponds to the direction of a lift force which can be generated and/or is generated by the first drive device, so that a lift (A1) can be generated or is generated by both the first drive device and the second drive device. Preferably, the direction of the propulsive force (A) generated by the second drive device is substantially perpendicular to the tailplane or the horizontal stabilizer.

Unlike aircraft in which, for example, both the wings and the tailplane together with propellers attached thereto or the respective propellers alone are tilted accordingly to generate lift, in this preferred embodiment only the tail (rear fuselage section or carrier elements) together with the tailplane located thereon and the second drive device which is preferably fixedly arranged thereon, in particular integrated in the tailplane, is tilted relative to the front fuselage.

As a result, the aircraft can be brought in a single operation—i.e., by pivoting the front fuselage section relative to the rear fuselage section or support elements, or by pivoting the rear fuselage section or support elements relative to the front fuselage section—into a configuration in which lift can be generated by both the first drive device (e.g., the front propeller) and the second drive device (e.g., the impeller or thrust vector), particularly when the longitudinal axis of the aircraft is oriented substantially vertically.

Alternatively or additionally, the second drive device can be configured to generate drive forces preferably in any direction.

Preferably, the propulsive forces generated by the second drive device may not only contribute to the lift of the aircraft in a vertical flight mode, but may also contribute to the change of direction and/or directional stabilization in a forward and/or vertical flight mode. For example, in forward flight mode and/or in the second hover mode, the direction of flight of the aircraft in the forward direction and/or in the vertical direction can be stabilized, for example by preventing the tail from “breaking away” upwardly and/or downwardly and/or laterally by generating appropriately directed propulsive forces. The same applies accordingly to a change of direction or steering of the aircraft by generating additional drive forces directed upwards and/or downwards and/or to one of the sides.

In a further preferred embodiment, the first drive device and/or the second drive device comprises or comprise a thrust vector control by which the strength and/or the direction of the propulsion or lift generated in each case can be varied. This enables steering movements, e.g. by specifically directing an exhaust jet of the respective drive device, for example by means of thrusters, deflection surfaces at a nozzle outlet or pivoting of the nozzle itself. This is particularly advantageous for vertical takeoff, in which the aircraft is carried by the vertically downward directed thrust during vertical takeoff. For horizontal or forward flight, the nozzles are pivoted to the appropriate position to first move the aircraft from the vertical orientation to a substantially horizontal orientation and then provide it with the propulsion required for forward flight, with lift then being generated by the wings in a conventional manner.

Preferably, a control device is provided which is configured to control the aircraft in a first hover mode in which the aircraft can take off and/or land such that the rear fuselage section or the at least one support element is or are pivoted to the second orientation substantially perpendicular to the longitudinal axis of the aircraft, wherein the longitudinal axis of the aircraft is substantially vertical, and the lift of the aircraft is generated by the first and second drive device.

Alternatively or additionally, the control device is configured to control the aircraft in a second hover mode, in which the aircraft can take off and/or land, such that the rear fuselage section or the at least one support element is pivoted to the first orientation which is substantially parallel to the longitudinal axis of the aircraft, wherein the longitudinal axis of the aircraft is substantially vertical, and the lift of the aircraft is generated by the first drive device.

Alternatively or additionally, the control device is configured to control the aircraft in a forward flight mode, in which the aircraft can fly forward, such that the rear fuselage section or the at least one support element is pivoted to the first orientation, which is substantially parallel to the longitudinal axis of the aircraft, wherein the longitudinal axis of the aircraft is substantially horizontal, and the propulsion of the aircraft is generated by the first drive device and the lift of the aircraft is generated by the wing and the tailplane.

Preferably, the control device is further configured to transition the aircraft from the second hover mode to the forward flight mode by temporarily activating the second drive device and/or activating the tailplane, in particular one or more control surfaces on the tailplane, so that the aircraft is rotated about the transverse axis.

Alternatively, the aircraft can transition directly or smoothly from the first hover mode, in which the aircraft can lift off the ground, for example, to the forward flight mode without intermediate operation in the second hover mode described above. In this case, for example, the rear fuselage section or the at least one support element is gradually pivoted from the second orientation, which is substantially perpendicular to the longitudinal axis of the aircraft, to the first orientation during the climb flight and, optionally, it is additionally ensured that the aircraft is rotated about the transverse axis, for example, by activating the second drive device and/or the tailplane, in particular one or more control surfaces on the tailplane, accordingly.

Further advantages, features and possible applications of the present invention will be apparent from the following description in connection with the figures showing:

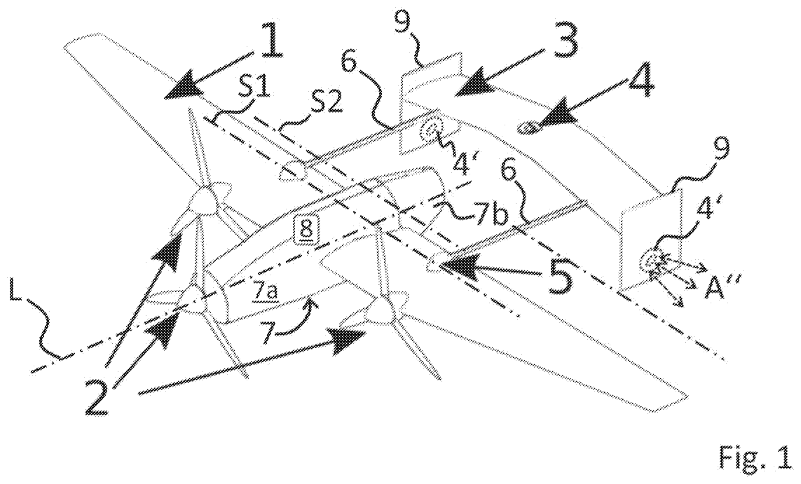

FIG. 1 a schematic representation of an example of an aircraft;

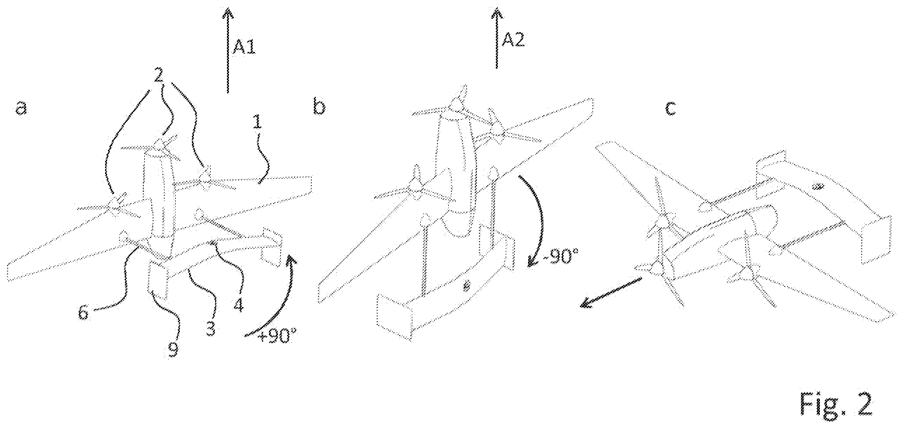

FIG. 2 a schematic representation of different configurations or modes of operation of the aircraft;

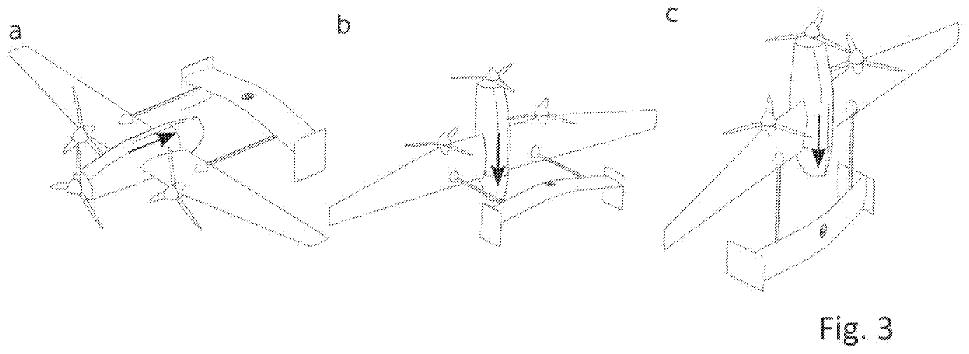

FIG. 3 a schematic representation of the aircraft to illustrate a shift in the center of mass in different configurations or modes of operation;

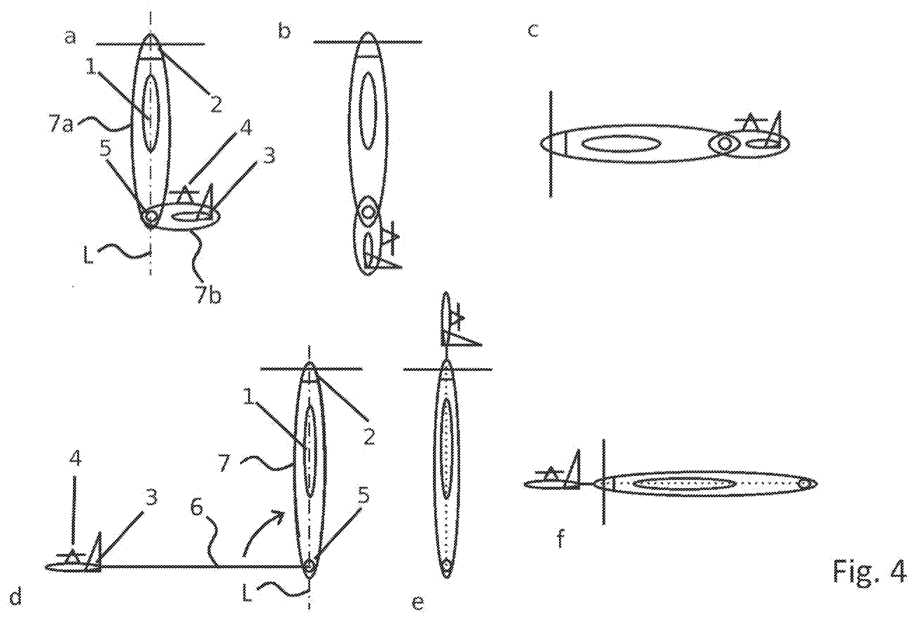

FIG. 4 a schematic representation of different configurations or operating modes based on two further examples of an aircraft;

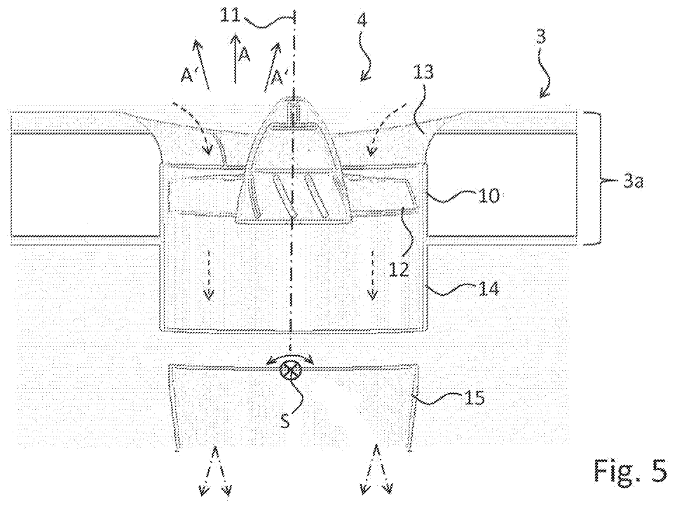

FIG. 5 a schematic cross-sectional view of an example of a second drive device integrated into the tailplane; and

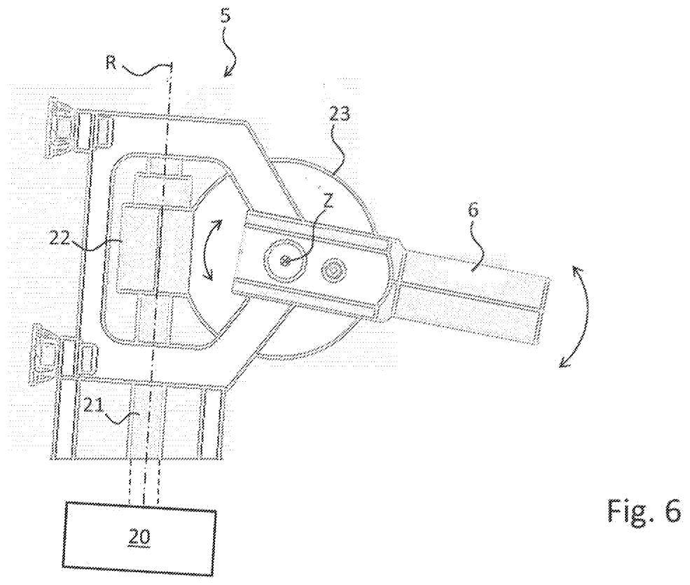

FIG. 6 a schematic side view of an example of a pivoting device.

FIG. 1 shows a schematic representation of an example of an aircraft or flying object that can take off and land vertically and is also referred to below as the “overall system”.

The overall system preferably comprises: a fuselage 7, a wing 1, a main drive system 2, an tailplane 3, an auxiliary drive system 4, and a pivoting mechanism 5.

In the present example, the main drive system 2, which is also referred to as the first drive device in the context of the present disclosure, has a propeller arranged at the front end (nose) of the fuselage 7 and a propeller arranged at each of the left and right portions of the wing 1.

The tailplane 3, which serves to stabilize and control the flight attitude about the transverse axis of the aircraft and thus also to control the angle of attack and the speed, comprises in the present example a, preferably fixed and/or non-pivoting, horizontal stabilizer, but can also be composed of a fixed and/or non-pivoting horizontal stabilizer and a movable and/or pivoting elevator (not shown), which is preferably pivotably mounted on the horizontal stabilizer. Alternatively or additionally, the tailplane 3 may have a horizontal stabilizer that pivots in itself. The tailplane 3 exerts a downward force on the tail during static straight flight to compensate for the top-heavy torque of the weight trim.

In the present example, two side wings 9, which may also be referred to as side fins, are provided on the tailplane 3, wherein the side wings 9 are attached to the lateral ends of the horizontal stabilizer and are oriented substantially perpendicular to the horizontal stabilizer.

The auxiliary drive system 4, which is also referred to as the second drive device in the context of the present disclosure, is preferably designed as an impeller in the example shown, which is integrated into the tailplane 3 or into the, in particular fixed, horizontal stabilizer.

In the present example, two, e.g. rail-shaped or tubular, support elements 6 are provided, which are attached with a front end to the pivoting mechanism 5 located on the wing 1. The tailplane 3 is attached to the rear end of the carrier elements 6. This allows the carrier elements together with the tailplane 3 located thereon to be pivoted or tilted about a pivot axis S1 extending through the pivoting mechanism 5 and/or substantially parallel to the transverse axis and/or substantially perpendicular to the longitudinal axis L of the aircraft.

The pivoting mechanism 5, which in the context of the present disclosure is also referred to as a pivoting device, is preferably configured as a self-locking mechanism and/or has a self-locking gear, by which the carrier elements 6 can be pivoted about the pivot axis S1, for example with the aid of a motor drive (not shown), and pivoting of the carrier elements 6 is prevented or at least made more difficult by forces or torques acting from outside on the tailplane 3 and/or the carrier elements 6.

In another embodiment not shown in FIG. 1, the tailplane 3 can be attached, rather than to rail-shaped or tubular support elements 6, to a rear fuselage section 7b of the fuselage 7 which can be pivoted relative to the front fuselage section 7a. In this case, the rear fuselage section 7b is preferably longer than in the example shown in FIG. 1. Furthermore, the pivoting mechanism 5 schematically indicated in FIG. 1 is preferably arranged in or on the fuselage 7 and appropriately dimensioned and/or configured to enable pivoting or tilting of the rear fuselage section 7b, including the tailplane 3 attached thereto, relative to the front fuselage section 7a about a pivot axis S2 extending substantially parallel to the transverse axis and/or substantially perpendicular to the longitudinal axis L of the aircraft.

In both variants, the pivoting mechanism 5 allows the overall system to be transformed between different reversible configurations, which preferably include at least two different hover modes and an aerodynamic mode, which is also referred to as a forward flight mode.

Preferably, the tailplane 3 or the horizontal stabilizer is fixed, and in particular cannot be pivoted in itself, to the carrier elements 6 or to the rear fuselage section 7b. Alternatively, however, the tailplane 3 or the horizontal stabilizer can be mounted on the carrier elements 6 or on the rear fuselage section 7b so as to be movable, in particular so as to be able to pivot in itself. In this case, the tailplane 3 or the horizontal stabilizer is not only pivotable together with the carrier elements 6 or the rear fuselage section 7b about the pivot axis S1 or S2, but also additionally about a further pivot axis (not shown) running on or in the area of the tailplane 3 or the horizontal stabilizer, which preferably runs parallel to the pivot axis S1 or S2 of the carrier elements 6 or the rear fuselage section 7b.

To control the aircraft in the different operating modes or configurations and corresponding transitions between the operating modes or configurations, a control device 8 is provided, by which the main drive system 2 and/or the tailplane 3 and/or the auxiliary drive system 4 and/or the pivoting mechanism 5 is/are controlled accordingly. This is explained in more detail below by means of examples.

FIG. 2 shows a schematic representation of different configurations or operating modes of the aircraft.

In the first hover mode, in which the aircraft is preferably in during take-off and/or landing, lift is generated by the main drive system 2 and the auxiliary drive system 4, as illustrated in FIG. 2a. In the example shown, the two support elements 6 together with the tailplane 3 attached thereto are folded up and extend substantially perpendicular to the substantially vertically oriented longitudinal axis L of the aircraft. The rear fuselage section 7b and/or the tailplane 3, in particular side wings 9 provided at the two outer ends of the tailplane 3, are thereby preferably configured in such a way that the aircraft, e.g. before take-off and/or after landing, can stand on the ground with the rear fuselage section 7b and the tailplane 3.

In the second hover mode, in which the aircraft is, for example, after take-off and/or before landing, lift is generated only by the main drive system 2, as illustrated in FIG. 2b.

Stabilization in the hover modes can be achieved by means of the main drive 2, auxiliary drive 4 and via control surfaces (not shown) on the wing 1 and/or the tailplane 3. The latter are located in the airflow of the main drive 2.

In aerodynamic mode, in which the aircraft is preferably in forward flight, propulsion is generated only by the main engine 2 and lift is generated by the wing 1 and the tailplane 3, as illustrated in FIG. 2c. The aircraft can be controlled by means of control surfaces on the wing 1 and on the elevator or tailplane 3.

For the takeoff procedure, the overall system lifts off in the first hover mode (FIG. 2a). After lift-off, the tailplane 3 is folded down by means of the pivoting mechanism 5 so that the second hover mode is reached (FIG. 2b). After folding down, the overall system accelerates and rotates to the aerodynamic mode (FIG. 2c). The control surfaces on the elevator or tailplane 3 and/or the auxiliary drive 4 can be used for the rotation.

The landing procedure starts in aerodynamic mode (FIG. 2c). The overall system first rotates into the second hover mode (FIG. 2b). The control surfaces on the elevator or tailplane 3 and/or the auxiliary drive 4 can be used for the rotation. In the second hover mode, the tailplane 3 is folded upward by means of a pivoting mechanism 5 to reach the first hover mode (FIG. 2a). The overall system can land again.

Unlike aircraft in which, for example, the wings and the tailplane together with propellers attached thereto and/or propellers pivotably mounted on the wings are each tilted by 90° for vertical takeoff, in the present aircraft preferably only the tail, i.e. the rear fuselage section 7b or the support elements 6, together with the tailplane 3 attached thereto and the second drive device 4 fixed to the tailplane 3 and/or integrated in the tailplane, is pivoted relative to the front fuselage 7a. Depending on the initial configuration, this also applies in reverse, i.e. the front fuselage section 7a or fuselage 7 is pivoted relative to the tail, i.e. the rear fuselage section 7b or the carrier elements 6 and the tailplane 3 located thereon.

This allows the aircraft to be brought into a configuration, in which lift (see arrow A1 in FIG. 2a) can be generated by both the first drive device 2 (e.g. propeller) and the second drive device 4 (e.g. impeller, thrust vector), by means of only one working or pivoting process, in which the front fuselage section 7a or fuselage 7 is pivoted relative to the rear fuselage section 7b or carrier elements 6 and/or the rear fuselage section 7b or carrier elements 6 is pivoted relative to the front fuselage section 7a or fuselage 7 by preferably +90°.

Preferably, the aircraft is controllable and/or configured such that the longitudinal axis L of the aircraft, preferably immediately, after the rear fuselage section 7b or the support elements 6 and/or the front fuselage section 7a or the fuselage 7 are pivoted into the configuration shown in FIG. 2a, runs substantially in the vertical direction. The rear fuselage section 7b and/or the support elements 6 then preferably run substantially in the horizontal direction.

Conversely, the aircraft can be brought from the configuration shown in FIG. 2a by means of only one working or pivoting process, in which the rear fuselage section 7b or the carrier elements 6 are pivoted by preferably −90° in the opposite direction relative to the front fuselage section 7a, into a configuration in which—e.g. after a vertical takeoff—lift (see arrow A2 in FIG. 2b) is generated only by the first drive device 2 (e.g. propeller).

For a further improved first and second hover mode, modifications can be made to the overall system as follows:

(1) Thrust vector control of the main drive system 2 and/or the auxiliary drive system 4. A thrust vector control is characterized by the ability to change the magnitude and direction of the generated lift vector of the various drive systems 2 and 4, respectively. Such a change is an efficient method of controlling the overall system.

(2) Shifting the aerodynamic center of gravity and at the same time the center of mass toward the tail of the tailplane 3 in aerodynamic mode (in the direction of the arrow in FIG. 3a). This shift moves the center of mass of the overall system downward in both hover modes (in the direction of the arrow in FIGS. 3b and 3c). This results in a more stable ground state of the overall system in the two hovering modes. This can be done statically, e.g., by appropriate design of the aircraft, or dynamically, e.g., during flight or transition between operating modes or configurations. To realize a dynamic center-of-mass shift, for example, a mass located in or on the fuselage 7 can be displaceably mounted in the direction of or parallel to the longitudinal axis L by means of a suitable displacement mechanism. The displaceably mounted mass can be provided, for example, by an additional mass body provided specifically for this purpose and/or by displaceably mounted cargo. Alternatively or additionally, however, the displaceable mass can also be given by an already existing component of the aircraft, such as batteries located in the fuselage 7. The displacement mechanism may, for example, comprise a carriage or belt by means of which the mass can be displaced or relocated, and a motor, for example a stepper motor, for driving the carriage or belt. Even if, in the aircraft shown by way of example in FIGS. 1 to 3, the tailplane 3 is attached to support elements 6 pivotably mounted on the wing 1, the embodiments described above also apply accordingly to the embodiment in which the tailplane 3 is attached to a pivotable rear fuselage section 7b or to the front fuselage section 7a. If the tailplane 3 is attached to the front fuselage section 7a, this may even be arranged in front of the wing 1, as viewed in the direction of flight, depending on the design. These and other embodiment variants are explained in more detail below by means of examples.

FIG. 4 shows different configurations or operating modes based on two further examples of an aircraft in a highly schematized side view.

In the example of an aircraft shown in FIGS. 4a to 4c, the rear fuselage section 7b is pivotably mounted on the front fuselage section 7a by means of a pivoting device 5. Attached to the front fuselage section 7a are the wing 1 and the main drive system 2, such as in the form of a propeller. Both the tailplane 3 and the auxiliary drive system 4 are attached to the rear fuselage section 7b and can be pivoted together with the latter relative to the front fuselage section 7a. In the present example, the pivot axis is substantially perpendicular to the drawing plane or longitudinal axis L of the aircraft. Analogous to the example shown in FIGS. 2a to 2c, FIG. 4a shows the first hovering mode in which the aircraft is preferably during take-off and/or landing, FIG. 4b shows the second hovering mode in which the aircraft is preferably after take-off and/or before landing, and FIG. 4c shows the aerodynamic mode in which the aircraft is preferably during forward flight. The above explanations in connection with FIGS. 2a to 2c apply accordingly to FIGS. 4a to 4c. Preferably, as indicated in FIG. 4a, the rear fuselage section 7b is designed, in particular dimensioned and/or shaped, such that the aircraft can stand with the rear fuselage section 7b on the ground in the first hovering mode, e.g. before take-off and/or after landing.

In the example of an aircraft shown in FIGS. 4d to 4f, the tailplane 3 and the auxiliary drive 4 are attached to one end of at least one carrier element 6, which is pivotably mounted with its other end on the rear region of the fuselage 7 by means of a pivoting device 5. Here, the pivoting device 5 is designed and/or the length of the at least one support element 6 is selected such that the at least one support element 6 can be pivoted towards the fuselage 7, and thereby preferably into a longitudinal plane or the longitudinal axis L of the fuselage 7 (see curved arrow). In this way, the tailplane 3 and the auxiliary drive 4 can be positioned in front of the fuselage 7 and/or in front of the main drive 2 and/or in front of the wing 1, as seen in the direction of flight, as indicated in FIGS. 4e and 4f. The above explanations in connection with FIGS. 2a to 2c apply accordingly to FIGS. 4d to 4f.

The described concept of the aircraft can be applied to man-carrying and unmanned systems.

FIG. 5 shows a schematic cross-sectional view of an example of a second drive unit 4 which is integrated in the tailplane 3 and designed as an impeller.

In the horizontal stabilizer 3a of the tailplane 3, of which only a section is shown in the illustration, an opening is provided in which an annular or tubular housing 10 is integrated. A propeller 12 rotatably mounted about a propeller axis 11 is arranged in the housing 10. The propeller 12 is attached to a drive shaft (not shown for illustrative purposes), which can be set in rotation by a motor (not shown).

The housing 10 preferably has an upper housing section 13, the diameter or cross-section of which increases, preferably continuously, starting from an area of the housing 10 in which the propeller 12 is arranged, towards the upper side of the horizontal stabilizer 3a and preferably merges into and/or is flush with the upper side of the horizontal stabilizer 3a. Alternatively or additionally, the housing 10 may have a lower housing portion 14 which extends beyond the lower side of the horizontal stabilizer 3a.

The airflow through the housing 10 caused by a rotation of the propeller 12, indicated by dashed arrows in FIG. 5, causes a drive force A, which can be used to maneuver the aircraft and/or, in particular in the first hover mode, supports a vertical takeoff or lift-off of the aircraft from the ground as an additional lift force (i.e., in addition to the lift force generated by the first drive device 2), as explained in more detail above in connection with FIG. 2a.

The second drive device 4, which is in the form of an impeller, is preferably fixed to the tailplane 3 and/or the horizontal stabilizer 3b, i.e. the impeller itself is preferably not pivotable, so that the direction of the drive force A with respect to the tailplane 3 and/or the horizontal stabilizer 3a is fixed or invariable.

In an alternative embodiment, the second drive device 4, designed as an impeller, may also be fixedly arranged on the tailplane 3 or on the horizontal stabilizer 3b, so that the impeller itself cannot be pivoted, but in the area of the lower end of the housing 10 and/or of the lower housing section 14, an air deflection device 15 may additionally be provided, by which the strength and/or the direction of the drive force A generated in each case can be varied.

In the present example, the air deflection device 15 has a tube tapering in the direction away from the impeller, which can be pivoted about a pivot axis S extending perpendicularly to the drawing plane, thereby deflecting the airflow emerging from the impeller perpendicularly to the horizontal tailplane 3b (indicated by dashed-dotted arrows) and causing a correspondingly changed drive force A′ in its direction.

The above-described operating principle of the air deflection device 15 is also referred to as thrust vector control in the context of the present disclosure.

Alternatively or in addition to the pivoting air deflection device 15, which is preferably in the form of a conical or tapering tube, thrust vector control can also be implemented by other measures in which an exhaust gas or air jet from the second drive device 2 is specifically directed, for example by means of thrusters, deflection surfaces at a nozzle or impeller outlet or pivoting of the nozzle or impeller itself.

Even if in the illustration of FIG. 5 the drive forces A, A′ generated by the second drive device 4, in particular in the form of an impeller, are directed upwards, the second drive device 4 can also be configured to generate drive forces directed in the opposite direction, in particular downwards, which are directed in the opposite direction to the drive forces A and A′ shown by way of example. These can easily be realized by reversing the direction of rotation of the propeller 12 of the second drive device designed as an impeller.

In principle, the second drive device 4 can be configured to generate drive forces in any direction.

Preferably, the propulsive forces generated by the second drive device 4 can contribute not only to the lift of the aircraft, but also to the change of direction and/or to the stabilization of direction during forward and/or vertical flight mode. For example, in the second hover mode shown in FIG. 2b, the direction of flight of the aircraft in the vertical direction can be stabilized, for example by preventing the tail from “breaking away” to the left or right, as the case may be, by generating drive forces directed to the right and/or left, as viewed in the plane of the drawing.

Preferably, a second drive device 4, in particular as described above, designed as an impeller, optionally together with an air deflection device 15, can also be integrated in one or both lateral wings 9 or fins. This is illustrated by the example of the aircraft shown in FIG. 1, in which two second drive devices 4′ optionally designed as impellers are integrated in both lateral wings 9. The drive devices 4′ are configured to generate drive forces A″, which are directed perpendicularly and/or at an adjustable or predeterminable angle to the longitudinal axis L of the aircraft, as indicated by dashed double arrows, and preferably serve to change direction and/or stabilize direction in forward and/or vertical flight mode. In this way, for example, the direction of flight of the aircraft can be stabilized in the vertical or forward flight mode shown in FIGS. 2a, 2b and 2c, for example by preventing the tail from “breaking away” to the side by generating corresponding laterally directed drive forces.

FIG. 6 shows a schematic side view of an example of a pivoting device 5, by means of which in each case a support element 6 is pivotably mounted on the fuselage 7 and/or on the wing 1 of the aircraft (see FIG. 1).

The pivoting device 5 has a pivot drive unit 20, in particular in the form of a motor, and a pivot gear, which in the present example has a drive shaft 21 which can be set in rotation about an axis of rotation R by the pivot drive unit 20 and to which a helical gear element 22, in particular in the form of a worm, is attached.

Furthermore, a gear wheel 23, in particular a bevel gear or worm gear, is provided, which is rotatably mounted about a gear wheel axis Z, which is substantially perpendicular to the axis of rotation R of the drive shaft 21 and preferably runs along the pivot axis S1 (see FIG. 1), and engages in the thread of the gear element 22 or the worm.

If the gear element 22 is caused to rotate about the axis of rotation R by the drive shaft 21 driven by the motor 20, then the gear wheel 23 together with the carrier element 6 attached to it is pivoted about the gear wheel axis Z, depending on the direction of rotation, which is indicated by the two double arrows.

Preferably, the transmission ratio of the rotational movement about the rotational axis R to the rotational or pivoting movement of the gearwheel 23 about the gearwheel axis Z is selected to be so large that the pivot gear is self-locking, i.e. that the gearwheel 23 and the carrier element 6 located thereon can preferably be pivoted only by a rotation of the drive shaft 21, but conversely a rotation of the drive shaft 21 by forces normally acting on the gearwheel 23 and/or the carrier element 6—i.e. in particular during operation of the aircraft—is not possible or is possible only within predetermined tolerances.

This allows the carrier elements 6 and the tailplane 3 located thereon (see FIG. 1) to be pivoted in a simple and robust manner relative to the fuselage 7 or the wing 1 and, moreover, to be reliably held in the pivoted position assumed in each case.

Even though in the example shown in FIG. 6 a carrier element 6 is pivoted with the aid of the pivoting device 5, the pivoting device 5 can of course also be provided to pivot the rear fuselage section 7b together with the tailplane 3 attached thereto relative to the front fuselage section 7a.

Even though in the example shown in FIG. 6 the pivot gear is preferably designed as a worm gear, the pivot gear can also be implemented in other ways.

For example, the drive shaft 21 can be designed as a threaded rod on which—instead of the worm 22—a threaded nut is threaded, which is coupled to the carrier element 6, which is mounted so as to be pivotable about the axis Z. If the threaded rod is set in rotation about the axis of rotation R by the motor 21, the threaded nut is displaced parallel to the axis of rotation R, resulting in a rotation of the carrier element 6 coupled thereto. In this embodiment, too, the transmission ratio can be selected so large that the pivot gear is self-locking.

1. An aircraft comprising at least one fuselage, which has a front fuselage section and a rear fuselage section, at least one wing provided in the region of the front fuselage section, at least one first drive device provided in the region of the front fuselage section and/or on the wing and configured to generate propulsion and/or lift, and at least one tailplane which is configured to rotate and/or stabilize the aircraft about a transverse axis of the aircraft during flight,
characterized in that the tailplane
is attached to the fuselage, and the rear fuselage section can be pivoted relative to the front fuselage section about a first pivot axis which is substantially parallel to the transverse axis of the aircraft, and/or
is attached to at least one support element which is mounted on the fuselage and/or on the wing and which can be pivoted relative to the fuselage and/or to the wing about a second pivot axis which is substantially parallel to the transverse axis of the aircraft.

2. The aircraft according to claim 1, comprising at least one pivoting device, which is configured to pivot the rear fuselage section relative to the front fuselage section and/or the at least one support element relative to the fuselage or the wing about the first or second pivot axis.

3. The aircraft according to claim 2, wherein the pivoting device is configured to pivot the rear fuselage section or the at least one support element from a first orientation to a second orientation which is substantially perpendicular to the first orientation.

4. The aircraft according to claim 3, wherein, in the first orientation, the rear fuselage section or the at least one support element is substantially parallel to a longitudinal axis of the aircraft, and, in the second orientation, the rear fuselage section or the at least one support element is substantially perpendicular to the longitudinal axis of the aircraft.

5. The aircraft according to claim 2, wherein the pivoting device comprises a pivot drive unit, in particular a motor, and a pivot gear mechanically coupled to the pivot drive unit, by means of which the rear fuselage section is pivotable relative to the front fuselage section and/or the at least one carrier element is pivotable relative to the fuselage and/or the wing about the first or second pivot axis, the pivot gear being designed as a self-locking gear.

6. The aircraft according to claim 5, wherein the pivot gear comprises:
a helical gear element, in particular a worm, which can be set into a rotational movement about a first axis of rotation by the pivot drive unit, and
a gear wheel, in particular a worm wheel, which engages in the helical gear element and can be rotated by a rotary movement of the gear element about the first axis of rotation about a second axis of rotation which is substantially perpendicular to the first axis of rotation and which preferably runs along the first or second pivot axis.

7. The aircraft according to claim 1, comprising at least one second drive device provided on the tailplane and/or on the rear fuselage section and/or on the at least one support element and configured to generate lift.

8. The aircraft according to claim 7, wherein the second drive device is designed as an impeller which is, in particular fixedly, integrated into the tailplane attached to the rear fuselage section or to the at least one support element.

9. The aircraft according to claim 7, wherein the second drive device is arranged and/or configured such that the second drive device generates a lift, in particular an additional lift, if in the second orientation the rear fuselage section or the at least one carrier element runs or is oriented substantially perpendicular to the, in particular vertically oriented, longitudinal axis of the aircraft.

10. The aircraft according to claim 7, wherein the second drive device provided on the tailplane is configured to generate a drive force in at least one direction, and, by pivoting, in particular only by pivoting,
the rear fuselage section together with the tailplane attached thereto about the first pivot axis or
the at least one carrier element together with the tailplane attached thereto about the second pivot axis,
the second drive device can be brought into a position and/or orientation in which the direction of the drive force which can be generated by the second drive device substantially corresponds to the direction of a lift force which can be generated by the first drive device, so that a lift can be generated by both the first drive device and the second drive device.

11. The aircraft according to claim 1, wherein the first drive device and/or the second drive device has or have a thrust vector control by which the strength and/or the direction of the respectively generated propulsion or lift can be varied.

12. The aircraft according to claim 1, comprising a control device configured to control the aircraft in a first hovering mode, in which the aircraft can take off and/or land, such that
the longitudinal axis of the aircraft is substantially vertical,
the rear fuselage section or the at least one support element is pivoted into a second orientation which is substantially perpendicular to the longitudinal axis of the aircraft, and
the lift of the aircraft is generated by the first and second drive device.

13. The aircraft according to claim 1, comprising a control device configured to control the aircraft in a second hovering mode, in which the aircraft can take off and/or land, such that
the longitudinal axis of the aircraft is substantially vertical,
the rear fuselage section or the at least one support element is pivoted into a first orientation which is substantially parallel to the longitudinal axis of the aircraft, and
the lift of the aircraft is generated, in particular only, by the first drive device.

14. The aircraft according to claim 1, comprising a control device configured to control the aircraft in a forward flight mode, in which the aircraft can fly forward, such that
the longitudinal axis of the aircraft is substantially horizontal,
the rear fuselage section or the at least one support element is pivoted into a first orientation which is substantially parallel to the longitudinal axis of the aircraft, and
the propulsion of the aircraft is generated, in particular only, by the first drive device, and the lift of the aircraft is generated by the wing and the tailplane.

15. A method for operating an aircraft, the aircraft comprising: at least one fuselage, which has a front fuselage section and a rear fuselage section, at least one wing provided in the region of the front fuselage section, at least one first drive device provided in the region of the front fuselage section and/or on the wing and configured to generate a propulsion and/or lift, and at least one tailplane which is configured to rotate and/or stabilize the aircraft about a transverse axis of the aircraft during flight,
characterized in that
the tailplane is attached to the fuselage, and the rear fuselage section is pivoted relative to the front fuselage section about a first pivot axis which is substantially parallel to the transverse axis of the aircraft and/or
the tailplane is attached to at least one support element which is mounted on the fuselage and/or on the wing and which is pivoted relative to the fuselage and/or the wing about a second pivot axis which is substantially parallel to the transverse axis of the aircraft.

16. The method according to claim 15, wherein a second drive device is provided on the tailplane and configured to generate a drive force in one direction, and, by pivoting, in particular only by pivoting,
the rear fuselage section together with the tailplane attached thereto about the first pivot axis and/or
the at least one carrier element together with the tailplane attached thereto about the second pivot axis,
the second drive device is brought into a position and/or orientation in which the direction of the drive force which can be generated and/or is generated by the second drive device substantially corresponds to the direction of a lift force which can be generated and/or is generated by the first drive device, so that a lift can be or is generated by both the first drive device and the second drive device.
